(19) United States
(12) Patent Application Publication
(10) Pub. No.: US 2009/0115991 A1
(43) Pub. Date: May 7, 2009

(54) ILLUMINATION SYSTEM OF A MICROLITHOGRAPHIC PROJECTION EXPOSURE APPARATUS

(75) Inventor: Damian Fiolka, Oberkochen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/272,297

(22) Filed: Nov. 17, 2008

Related U.S. Application Data
(63) Continuation of application No. PCT/EP2007/005943, filed on Jul. 5, 2007.

(30) Foreign Application Priority Data
Jul. 15, 2006 (DE) 10 2006 032 878.7

(51) Int. Cl. G03B 27/72

(52) U.S. Cl. 355/71

(57) ABSTRACT

The disclosure relates to an illumination system of a microlithographic projection exposure apparatus, such as a an illumination system with which it is possible to set up an illumination angle-dependent polarisation state of the projection light incident on a mask, as well as related systems, components and methods.

### CROSS-REFERENCE TO RELATED APPLICATIONS

This application is a continuation application of and claims priority to International Application No. PCT/EP2007/005943, filed on Jul. 5, 2007, which claims priority to German Application No. 10 2006 032 878.7, filed Jul. 15, 2007. The contents of both of these applications are hereby incorporated by reference.

### FIELD

The disclosure relates to an illumination system of a microlithographic projection exposure apparatus, such as a an illumination system with which it is possible to set up an illumination angle-dependent polarisation state of the projection light incident on a mask, as well as related systems, components and methods.

### BACKGROUND

Integrated electrical circuits and other microstructured components are conventionally produced by applying a plurality of structured layers onto a suitable substrate which, for example, may be a silicon wafer. In order to structure the layers, they are first covered with a photoresist which is sensitive to light of a particular wavelength range, for example light in the deep ultraviolet (DUV) spectral range. The wafer coated in this way is subsequently exposed in a projection exposure apparatus. A pattern of diffracting structures, which is arranged on a mask, is thereby imaged onto the photoresist with the aid of a projection objective. Since the imaging scale is generally less than 1, such projection objectives are often also referred to as reducing objectives.

After the photoresist has been developed, the wafer is subjected to an etching process so that the layer becomes structured according to the pattern on the mask. The photoresist still remaining is then removed from the other parts of the layer. This process is repeated until all the layers have been applied onto the wafer.

The projection exposure apparatus used for the exposure contain an illumination system, which illuminates the structures to be projected on the mask with a projection light beam. As its light source, the illumination system generally contains a laser which generates linearly polarised light.

### SUMMARY

In some embodiments, the disclosure provides an illumination system of a microlithographic projection exposure apparatus, with which the polarisation state of the projection light can be set up in a controlled way as a function of the illumination angle at which light rays arrive on the mask.

In certain embodiments, the disclosure provides an illumination system having a first optical arrangement for generating a light beam in which, at least over a part of the cross section of the light beam, the light has different polarisation states and is at least partially spatially coherent. A second optical arrangement is furthermore provided, which is arranged between the first optical arrangement and a pupil plane. The second optical arrangement splits the light beam onto at least two different positions in the pupil plane and superposes the polarisation states generated by the first optical arrangement to form pupil polarisation states which are different at the at least two positions.

The disclosure is based, at least in part, on the discovery that, by controlled superposition of coherent light components with different polarisation states in a pupil plane, it is possible to achieve an intensity distribution in which the polarisation state of the light depends in a desired way on the position, so that—in relation to the mask plane—the desired dependency of the polarisation state on the illumination angle is set up.

The first optical arrangement may for example include a thermal light source from the light of which, with the aid of an aperture plate, coherent but unpolarised light is generated. With the aid of polarisation filters and optionally additional retardation plates, from this it is possible to generate for example different linear, circular or elliptical polarisation states which are then superposed in the pupil plane with the aid of diffracting or refracting optical elements to form the desired polarisation state.

In some embodiments, the polarisation states of the light beam which is generated by the first arrangement change continuously and periodically along at least one direction at least over the part of the cross section of the light beam. Within wide limits, this makes it possible to set up any desired polarisation states in the pupil plane by suitable superposition.

The first optical arrangement can be produced particularly simply when the light source generates linearly polarised and at least partially spatially coherent projection light, as is the case for instance with lasers. With the aid of a birefringent prism, the polarisation state of a light beam passing through can then be modified periodically along one direction. The prism must merely have the property that its thickness varies only along one direction. This condition is fulfilled, for example, by a wedge-shaped prism. Since the thickness changes continuously in this case, the polarisation state of a light beam passing through also varies continuously along this direction. A similar effect is achieved if a plurality of sections, inside which the thickness changes continuously, adjoin one another discontinuously. An example of this is, for example, a prism with a sawtooth-like profile.

In certain embodiments, the prism has a stepped thickness profile instead of a continuous thickness profile. If the steps rise in one direction, then the shape of a staircase is imparted overall to the prism. A prism with a stepped thickness profile can modify the polarisation state of a light beam passing through, not continuously but discontinuously along the direction in which the thickness of the prism changes. In general, the more steps are provided per unit length, the less the polarisation state obtained by superposition will depend on thickness tolerances.

If the prism has an optical birefringence axis which makes an angle of 45° with a polarisation direction of the linearly polarised projection light, then all conceivable polarisation states can be generated. This in turn can be a prerequisite for all conceivable polarisation states also being achievable in the pupil plane by suitable superposition of coherent, differently polarised light components.

In certain embodiments, the second arrangement includes a diffractive optical element which has locally varying diffraction properties. The use of diffractive optical elements can be favourable in so far as virtually any desired angle distributions can thereby be generated. An intensity distribution in the pupil plane corresponds in the far-field to the angle distribution generated by the diffractive optical element.

If the diffractive optical element includes at least two strips arranged mutually parallel, with different diffraction properties, then, particularly in conjunction with a birefringent prism, two positions or regions with different polarisation states can be illuminated in the pupil plane.

### BRIEF DESCRIPTION OF THE DRAWINGS

Other features and advantages may be found in the following description of exemplary embodiments with the aid of the drawings, in which:

FIG. 1 shows a projection exposure apparatus in a highly schematised perspective representation;

FIG. 2 shows an illumination system in a simplified meridian section;

FIG. 3 shows a diffractive optical element having strip-shaped diffraction regions in a perspective representation;

FIG. 4 shows an enlarged detail of FIG. 2 in an X-Z section;

FIG. 5 shows an enlarged detail of FIG. 2 in a Y-Z section;

FIG. 6 shows the intensity and polarisation distribution set up in the pupil plane of the illumination system shown in FIG. 2;

FIG. 7 shows an arrangement of a birefringent wedge and the diffractive optical element shown in FIG. 3, in an X-Z section;

FIG. 8 shows the intensity and polarisation distribution set up in the pupil plane of an illumination system;

FIG. 9 shows a representation, based on FIG. 3, of a diffractive optical element;

FIG. 10 shows the intensity and polarisation distribution obtained in the pupil plane with the diffractive optical element shown in FIG. 9, in a representation based on FIGS. 6 and 8;

FIG. 11 shows a representation, based on FIG. 7, of an arrangement of a stepped prism and the diffractive optical element shown in FIG. 3, in an X-Z section;

### DETAILED DESCRIPTION

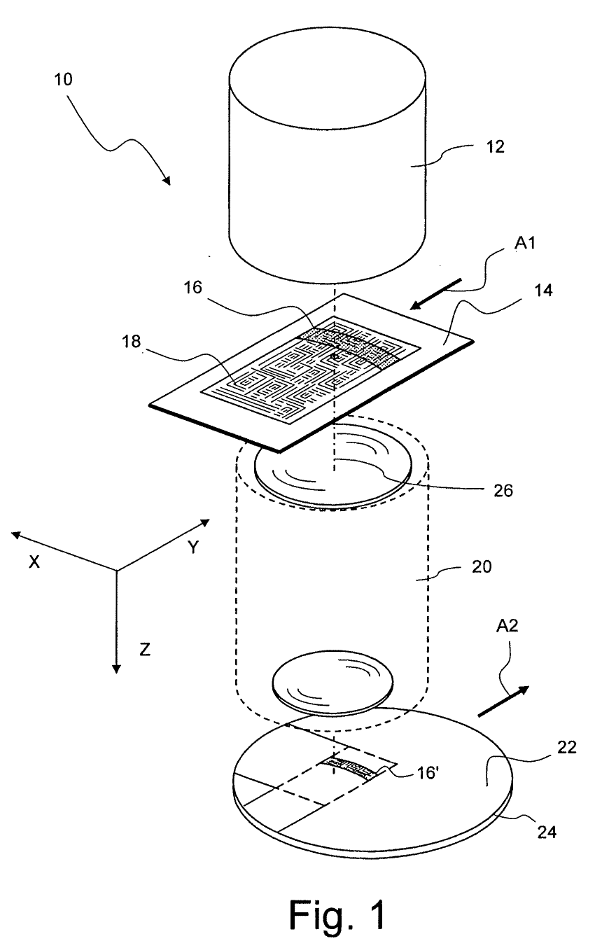

FIG. 1 shows a highly schematised perspective representation of a projection exposure apparatus 10, which is suitable for the lithographic production of microstructured components. The projection exposure apparatus 10 contains an illumination system 12 for generating a projection light beam that illuminates a narrow light field 16, which is shown as having the shape of a ring segment, on a mask 14. Structures 18 lying inside the light field 16 on the mask 14 are imaged with the aid of a projection objective 20 onto a photosensitive layer 22. The photosensitive layer 22, which may for example be a photoresist, is applied on a wafer 24 or another suitable substrate and lies in the image plane of the projection objective 20. Since the projection objective 20 generally has an imaging scale β<1, the structures 18 lying inside the light field 16 are imaged in a reduced fashion as region 16′.

In the projection exposure apparatus 10 represented, the mask 14 and the wafer 24 are displaced along a direction denoted by Y during the projection. The ratio of the displacement speeds is equal to the imaging scale β of the projection objective 20. If the projection objective 20 generates inversion of the image, then the displacement movements of the mask 14 and the wafer 22 will be in opposite directions as is indicated by arrows A1 and A2 in FIG. 1. In this way, the light field 16 is guided in a scanning movement over the mask 14 so that even sizeable structured regions can be projected coherently onto the photosensitive layer 22. The Y direction will therefore also be referred to as the scanning direction. The projection exposure apparatus may however be configured as a wafer stepper, in which no displacement movements take place during the projection.

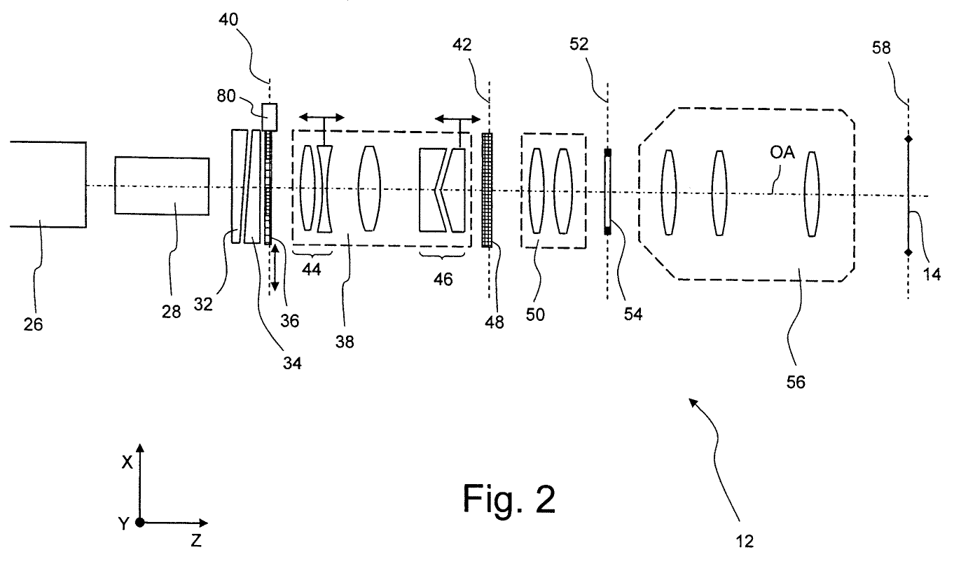

FIG. 2 shows details of the illumination system 12 in a simplified meridian section which is not true to scale. The illumination system 12 contains a light source 26, which generates at least partially spatially coherent projection light. Lasers are particularly suitable as the light source 26, since the light emitted by lasers is spatially and temporally coherent to a high degree. In the exemplary embodiments described here, the light source 26 is an excimer laser with which light in the (deep) ultraviolet spectral range can be generated. The use of short-wave projection light is advantageous because a high resolution can thereby be achieved for the optical imaging. Excimer lasers with the laser media KrF, ArF or F₂, by which light with the wavelengths 248 nm, 193 nm and 157 nm can respectively be generated, are conventional.

At least in principle, however, thermal light sources are also suitable if (partially) coherent light beams can be produced from the light generated by them, for example by using small aperture openings.

The light generated by the excimer laser used as the light source 26 is highly collimated and diverges only weakly. It is therefore initially expanded in a beam expander 28. The beam expander 28 may for example be an adjustable mirror arrangement, which increases the dimensions of the approximately rectangular light beam cross section.

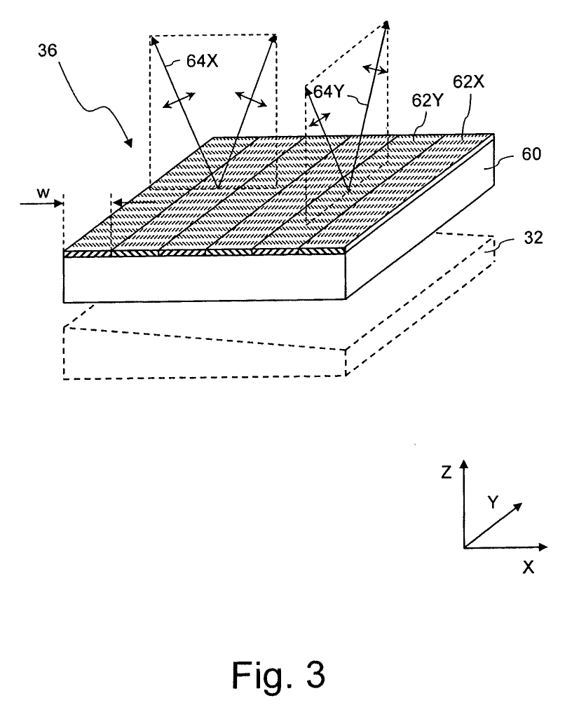

The expanded light beam subsequently passes through an optically birefringent wedge-shaped prism, which for brevity will be referred to below as a wedge 32, a compensator element 34 and a diffractive optical element 36. With the aid of these optical elements, which will be explained in detail below with reference to FIGS. 3 to 9, it is possible to set up illumination angle distributions in which the polarisation state depends on the illumination angle.

The diffractive optical element 36 is followed by a zoom-axicon module 38 which establishes a Fourier relation between a field plane 40, in which the diffractive optical element 36 is arranged, and a pupil plane 42. All light rays coming from the field plane 40 at the same angle therefore arrive at the same point in the pupil plane 42, whereas all light rays coming from a particular point in the field plane 40 pass through the pupil plane 42 at the same angle.

The zoom-axicon module 38 contains a zoom objective denoted by 44 and an axicon group 46, which contains two axicon elements with conical and mutually complementary faces. With the aid of the axicon group 46, the radial light distribution can be modified so as to achieve ring-shaped illumination of the pupil plane 42. By adjusting the zoom objective 44, it is possible to modify the diameter of the regions illuminated in the pupil plane 42.

An optical integrator 48, which may for example be an arrangement of microlens arrays, is arranged in or in the immediate vicinity of the pupil plane 42. Each microlens forms a secondary light source, which generates a divergent light beam with an angle spectrum dictated by the geometry of the microlens. By a condenser 50, the light beams generated by the secondary light sources are superposed in an intermediate field plane 52 so that it is illuminated very homogeneously.

In the exemplary embodiments represented, a field aperture 54, which may for example include a plurality of adjustable blades and/or a multiplicity of narrow finger-like aperture elements that can be inserted individually into the light path, is arranged in the intermediate field plane 52. With the aid of a field aperture objective 56, the intermediate field plane 52 is imaged onto the object plane 58 of the projection objective 20, in which the mask 14 is arranged.

FIG. 3 shows the diffractive optical element 36 in a perspective representation. Below it, the wedge 32 is indicated by dashes in order to illustrate the relative arrangement between the diffractive optical element 36 and the wedge 32. The compensator element 34, arranged between them in these exemplary embodiments, is not represented for the sake of clarity.

The diffractive optical element 36 includes a substrate 60 which on at least one side, here on the side facing away from the wedge 32, bears differently structured regions. In the exemplary embodiments represented, these regions are a periodic arrangement of strips 62X, 62Y, all of which have the same width w. Each of the strips 62X contains diffraction structures which diffract the light in the X direction, as indicated in FIG. 3 for two diffraction orders denoted by 64X. The diffraction angle in the Z-X plane is intended to be symmetrical with respect to a Z-Y plane.

For the strips 62Y, similar considerations apply to the Y direction i.e. they diffract the light exclusively in the Y-Z plane, which is indicated in FIG. 3 by two diffraction orders 64Y.

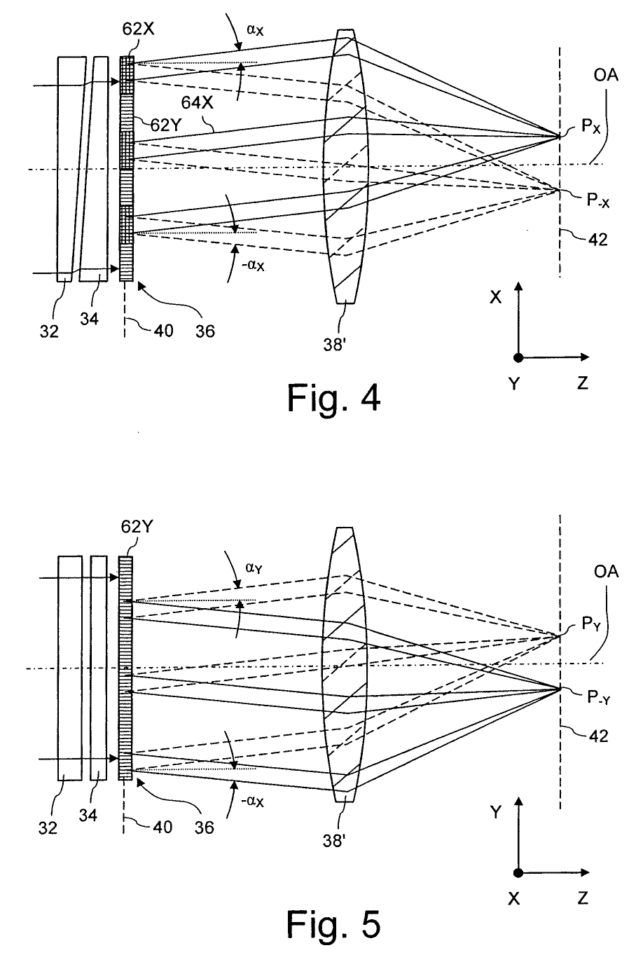

FIG. 4 shows the wedge 32, the compensator element 34 and the diffractive optical element 36 in a section parallel to the X-Z plane. The zoom-axicon module is indicated here only by a lens 38′, which establishes a Fourier relation between the field plane 40 and the pupil plane 42. Owing to this Fourier relation, all parallel light rays coming at the same angle from the diffractive optical element 36 arrive at the same point. If the strips 62X diffract collimated light passing through exclusively in the X-Z plane by angles +α_{X} and −α_{X}, as is indicated in FIG. 4 by lines represented solidly and in dashes, respectively, then the rays diffracted by the angle α_{X} all arrive at a point P_{X} in the pupil plane 42 and the rays diffracted by the angle −α_{X} all arrive at a point P_{-X}. In this way two points, which are equally far away from an optical axis OA of the illumination system 10 and lie diametrically opposite one another, are illuminated in the pupil plane 42.

Similar considerations also apply for the strips 62Y, which diffract the light exclusively in the Y-Z plane. This is shown in FIG. 5 which shows the wedge 32, the compensator element 34 and the diffractive optical element 36 in a section parallel to the Y-Z plane. Here again the light rays emerging at the angles α_{Y} and −α_{Y} arrive at two points P_{Y} and P_{-Y}, respectively, in the pupil plane 42.

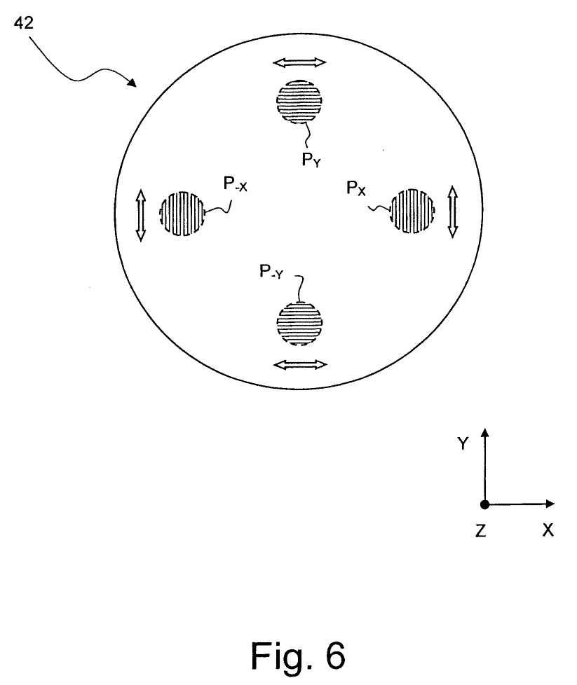

The light distribution generated in the pupil plane 42 by the diffractive optical element 36 is shown in FIG. 6. Here, it is assumed that the diffraction by the strips 62X, 62Y has been determined so that extended poles denoted by P_{X}, P_{-X}, P_{Y} and P_{-Y} are formed instead of points. The diffraction structures are so small that, in the strips 62X, 62Y, each region over the extent of which the thickness change of the wedge 32 is negligibly small generates an angle spectrum which leads to a pair of poles P_{X}, P_{-X} and P_{Y}, P_{-Y}, respectively, in the far-field i.e. in the pupil plane 42.

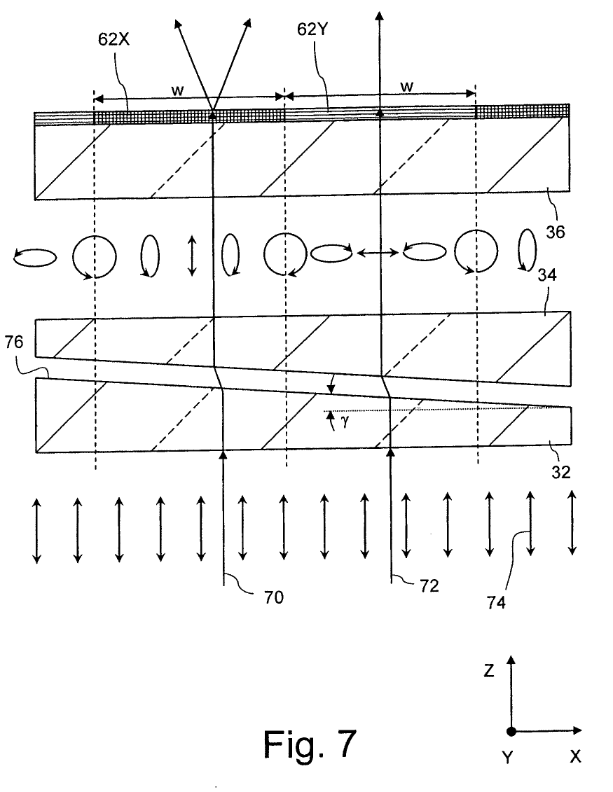

FIG. 7 shows the wedge 32, the compensator element 34 and the diffractive optical element 36 on an enlarged scale in a section parallel to the X-Z plane. As already explained, substantially collimated, linearly polarised and to a high degree spatially coherent laser light strikes the wedge 32. Two rays of the light beam incident on the wedge 32 are denoted by 70, 72 in FIG. 7. The linear polarisation direction of the laser light within the X-Y plane is indicated by double arrows 74, the double arrows 74 thus being represented “folded up” by 90°.

The wedge 32 consists of a birefringent material, for example magnesium fluoride. The wedge 32 has a wedge angle γ and an optical birefringence axis, which makes an angle of 45° with the polarisation direction 74 of the incident projection light. Owing to the upper wedge surface 76 being arranged inclined by the wedge angle γ, the light rays 70, 72 are refracted when they emerge from the wedge 32 and thereby deviated in their direction. The compensator element 34 has the task of making it possible to cancel out this deviation. The compensator element 34 is therefore likewise wedge-shaped, although the wedge angle may differ from the wedge angle γ of the wedge 32 depending on the refractive index of the compensator element 34.

The polarisation state in the X-Y plane, after the light has passed through the birefringent wedge 32, is indicated between the compensator element 34 and the diffractive optical element 36. This representation is also (like the double arrows 74) “folded up” by 90°. The polarisation state of a light ray after passing through the wedge 32 depends on how thick the wedge 32 is at the respective crossing point. Since the thickness of the wedge 32 varies continuously in the X direction, the polarisation state also changes continuously along this direction. As viewed over the X direction, all polarisation states thus occur as represented in FIG. 7 below the diffractive optical element 36. It may also be seen from this representation that the variation of the polarisation state is periodic with the period p. The width w of the strips 62X, 62Y is selected so that p=2w.

It will be assumed below that the projection light is fully coherent spatially and temporally within a strip width w. For a typical excimer laser, after the beam expansion in the beam expander 28, the spatial coherence is typically of the order of about 1 to 2 mm. The assumption of full coherence is therefore approximately satisfied for strip widths w of less than 0.5 mm, even better less than 0.25 mm.

It will furthermore be assumed below that two spatially and temporally coherent photons a and b pass through one of the strips 62X. If the two photons a, b have a phase which is opposite in sign and equal intensities after passing through the wedge 32, then the photons a, b will be superposed to form linearly polarised light in the pupil plane 42. This utilises the fact that superposition of the light rays diffracted at the same angle occurs at one point owing to the zoom-axicon module 38, as was explained above with reference to FIGS. 4 and 5. The assumption of equal light intensities is justified because the intensity is virtually constant at closely neighbouring positions within a continuously shaped laser beam profile.

The superposition of the two photons a, b considered here, to form linearly polarised light, can be described mathematically by Eq. (1):

$${E}_{1 a} + {E}_{1 b} = ( \begin{matrix}{E}_{p 1 a} {e}^{iμ} \\ {E}_{s 1 a}\end{matrix} ) + ( \begin{matrix}{E}_{p 1 b} {e}^{- iμ} \\ {E}_{s 1 b}\end{matrix} ) = 2 \cdot ( \begin{matrix}cos ( μ ) \\ 1\end{matrix} ) , \qquad Eq . ( 1 )$$

where E₁ₐ and E_{1b} are the electric field vectors of the two photons a and b, and μ describes the phase and therefore the polarisation state of the field vectors. The quantities Eₚ₁ₐ, Eₛ₁ₐ, E_{p1b}, and E_{s1b}, which are set equal to 1 here, denote the real components of the electric field vectors E₁ₐ and E_{1b} parallel and perpendicular to the optical birefringence axis of the wedge 32, respectively.

Addition of the two photons a and b in the pupil plane 42 therefore gives according to Eq. (2) light which is linearly polarised, but whose polarisation direction is rotated by the angle

arctan(1/cos(μ)) Eq. (2)

relative to the initial state.

Yet since all photons diffracted at the same angle arrive at one point in the pupil plane, superposition of all photons which pass through a strip 62X with the width w takes place. Owing to the relation p=2w, the phases μ of the photons lie in a range of between −π/2 and +π/2. Mathematically, the superposition can be described as

$${E}_{p} = {\int }_{- π / 2}^{π / 2} {e}^{iμ / 2} d μ = 2 \cdot \sqrt{2} and {E}_{s} = {\int }_{- π / 2}^{π / 2} {e}^{- iμ / 2} d μ = 2 \cdot \sqrt{2} . \qquad Eq . ( 3 )$$

The superposition of all photons passing through the strip 62X with polarisation states between left- and right-circularly polarised thus gives linearly polarised light, whose polarisation direction here is parallel to the polarisation direction 74 which the light had before passing through the wedge 32.

Corresponding considerations also apply for the strips 62Y, except that in this case the superposition leads to linearly polarised light whose polarisation direction is rotated by 90° relative to the original polarisation direction 74. The linear polarisation directions resulting from the superposition are indicated by double arrows in FIG. 3 for the diffraction orders 64X, 64Y.

Owing to the superposition described above, the two pole pairs mutually rotated by 90°, P_{X}, P_{-X} on the one hand and P_{Y}, P_{-Y} on the other hand, have polarisation states rotated by 90° relative to one another as is indicated by double arrows in FIG. 6. Overall, this leads to a tangential polarisation which is particularly favourable for imaging certain masks 14.

So that the wedge 32 gives the desired polarisation states in the exemplary embodiments described above, there must be the following relationship between the period p=2w and the wedge angle γ:

$$γ = arctan ( \frac{λ}{p \cdot Δ n} ) , \qquad Eq . ( 4 )$$

where λ the wavelength of the light, and Δn is the magnitude of the difference between the refractive index nₒ of the ordinary ray and the refractive index nₑ of the extraordinary ray in the birefringent wedge 32 at the wavelength λ. Furthermore, the arrangement of the strips 62X, 62Y is selected here so that one strip 62X and one strip 62Y are fully accommodated within one period with the width p.

It is of course possible to use a further birefringent wedge instead of the compensator element 34. In comparison with the exemplary embodiments shown in FIG. 7, the two wedges must then have the same wedge angle γ/2. As an alternative to this, the width w of the strips 62X, 62Y may also be halved if both birefringent wedges have the wedge angle γ.

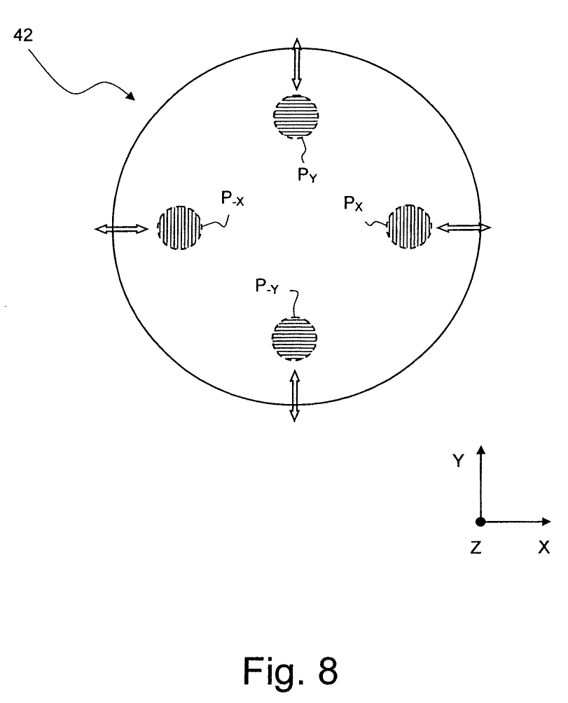

If other polarisation states, for example elliptical polarisation states, are intended to be set up in the poles P_{X}, P_{-X}, P_{Y} and P_{-Y} then it is sufficient to displace the diffractive optical element 36 relative to the wedge 32 along the X direction. Then, together with a suitable displacement device denoted by 80 in FIG. 2, the diffractive optical element forms a simply constructed polarisation manipulator for setting up different polarisation states in the pupil plane 42. If the diffractive element 36 is in this case displaced by one half period p/2 along the X direction, then poles P_{X}, P_{-X}, P_{Y} and P_{-Y} with light polarised linearly in the radial direction will be obtained in the pupil plane 42, as shown in FIG. 8.

In principle it is also possible to provide more than two different types of differently diffracting strips, in which case the arrangement of these strips also need not necessarily be equidistant. This makes it possible to set up partially polarised poles in the pupil plane 42.

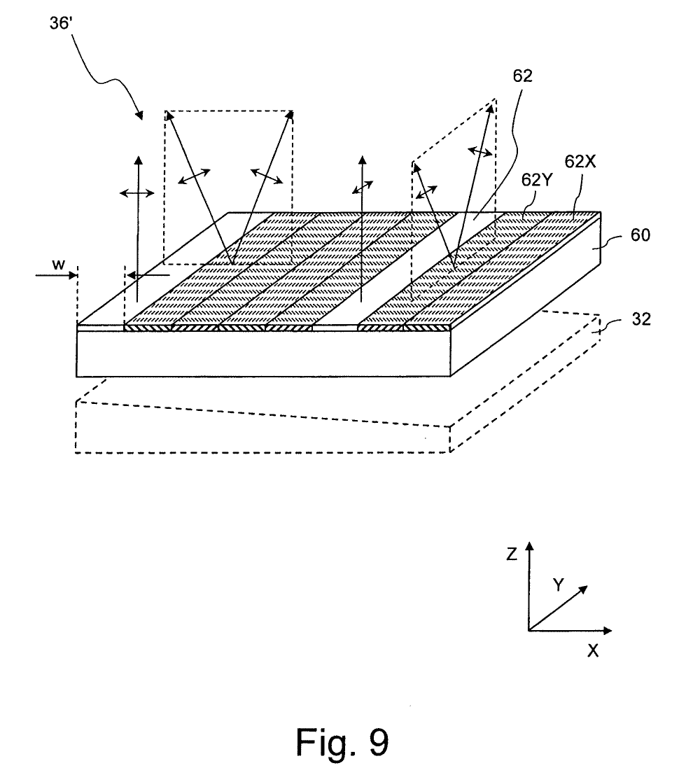

FIG. 9 shows a perspective representation, based on FIG. 3, of a diffractive optical element which is denoted here by 36′. In contrast to FIG. 3, the diffractive optical element 32 contains strips 62 which contain no diffraction structures. The light passing through the strips 62 therefore remains collimated parallel to the optical axis.

In FIG. 9, all strips 62, 62X and 62Y have the same strip width w=p/2. However, since the strips 62 not provided with diffraction structures are arranged offset from one another by two and a half (in general 2 m+½) periods in the exemplary embodiments represented, the light coming from neighbouring unstructured strips 62 is polarised mutually orthogonally. If the distance between the unstructured regions 62 is furthermore large enough so that there is no longer any significant coherence relation between the photons coming from neighbouring strips, then incoherent superposition of orthogonal polarisation states takes place in the pupil plane 42, which leads to unpolarised light.

Since no diffraction takes place in the strips 62, the light emerging parallel to the optical axis from the strips 62 will be focused by the zoom-axicon module 38 at a point lying on the optical axis in the pupil plane 42.

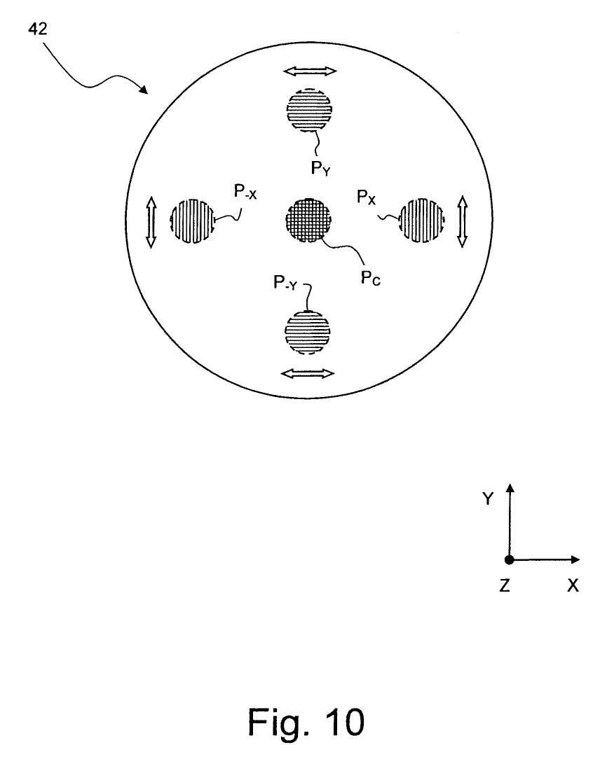

If a central extended pole is intended to be illuminated with unpolarised light in the pupil plane 42, then weakly diffracting structures, which deviate the light only by relatively small angles, may be provided in the regions 62. FIG. 10 shows the pupil plane 42 then obtained, in a representation based on FIGS. 6 and 8. In the middle of the pupil plane 42, there is an additional pole which is denoted by PC and through which unpolarised light passes.

An alternative option for generating an unpolarised pole consists in providing strips, the width of which is much larger than the spatial coherence cells of the laser light, on the diffractive optical element 36. If the strip width is then exactly a multiple of the period p, then unpolarised light is obtained, as may also be found similarly described in U.S. Pat. No. 6,535,273.

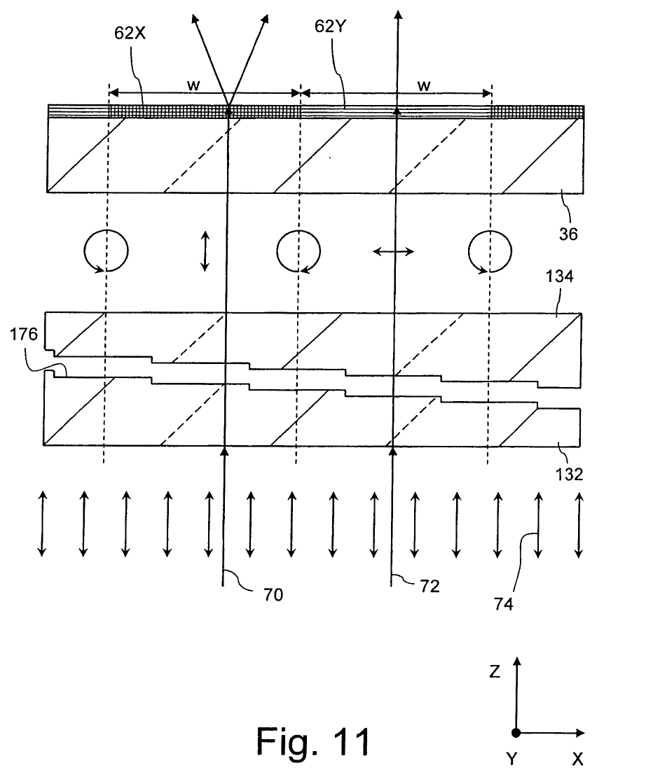

FIG. 11 shows a further possible way in which different polarisation states can be generated, in a representation based on FIG. 7. The alternative arrangement shown in FIG. 11 includes a birefringent stepped prism 132, a compensator element 134, and the diffractive optical element 36 from FIG. 3.

The birefringent prism 132 is substantially configured in the same way as the wedge 32 in FIG. 7. In particular, here again the optical birefringence axis makes an angle of 45° with the polarisation direction 74 of the incident projection light. The inclined wedge surface 76, which leads to a continuous thickness change in FIG. 7, is however replaced in the birefringent prism 132 by a stepped surface 176 whose steps rise along the X direction. The shape of a staircase is therefore imparted overall to the birefringent prism 132.

The compensator element 134 is likewise designed as a stepped prism, but without being birefringent. The compensator element 134 may be involved only for the case in which not only axially parallel rays 70, 72, but also rays which are (slightly) inclined with respect to the optical axis, strike the birefringent prism 132 from below. The compensator element 134 then ensures that the direction distribution of the rays passing through the prism 132 and the compensator element 134 remains unchanged. To this extent, the effect of the compensator element 134 corresponds in principle to the effect of the compensator element 34 of the arrangement shown in FIG. 7. In the event of refractive index deviations, the compensator element 134 may also include refracting surfaces arranged in an inclined fashion. For light which is axially parallel to a high degree, the compensator element 134 may entirely be omitted.

The stepped surface 176, and therefore the distribution of the thickness (dimension along the Z direction) of the birefringent prism 132 along the X direction, is established so that substantially collimated incident light polarised linearly in the Y direction (see “folded-up” double arrows 74) and light which is spatially coherent to a high degree is either unchanged in its polarisation state, or the polarisation direction is rotated by 90° or it is converted into right- or left-circularly polarised light.

In the exemplary embodiments represented, the distribution of the thickness is furthermore established so that the strips 62X, 62Y respectively receive light whose polarisation state in the X direction changes from circularly polarised to linearly polarised to circularly polarised in the reverse sense. This sequence of polarisation states is also periodic with the period p here, where likewise p=2w.

As may readily be seen with the aid of FIG. 11, during the superposition of light which passes through one of the strips 62X, 62Y, the X components or the Y components in the circular polarisation states respectively cancel each other out so that only the Y components or X components remain in each case. At the superposition points in the pupil plane 42, in these exemplary embodiments as well the light is therefore polarised linearly either along the Y direction or along the X direction.

Of course, the stepped surface 176 may also be configured differently. For example, two or more than three different thicknesses may be allocated to each strip 62X, 62Y. For example, it is feasible to provide two thicknesses which convert linearly polarised light into light polarised elliptically in opposite senses. So that the polarisation state obtained at the superposition points is as insensitive as possible to thickness tolerances of the birefringent prism 132, in general it is however more favourable for each zone 62X, 62Y to be allocated more rather than fewer different thicknesses. This is because when a greater number of different polarisation states are superposed, it becomes commensurately less important if an individual thickness does not correspond to the specified value. Furthermore, thickness tolerances can then also be mutually compensated for more easily.

What is claimed is:

1. An illumination system having a pupil plane, the illumination system comprising:
a first optical arrangement configured to generate a light beam in which, at least over a part of a cross section of the light beam, the light has different polarisation states and the light is at least partially spatially coherent; and
a second optical arrangement between the first optical arrangement and the pupil plane of the illumination system, the second optical arrangement configured to split the light beam onto at least two different positions in the pupil plane while superposing the polarisation states generated by the first optical arrangement to form pupil polarisation states which are different at the at least two positions,
wherein the illumination system is configured to be used in a microlithographic projection exposure apparatus.

2. The illumination system according to claim 1, wherein the polarisation states of the light beam generated by the first optical arrangement change continuously and periodically along at least one direction at least over the part of the cross section of the light beam.

3. The illumination system according to claim 2, wherein the first optical arrangement comprises:
a light source configured to generate linearly polarised and at least partially spatially coherent projection light; and
a birefringent prism configured to modify the polarisation state of a light beam passing therethrough, periodically along the at least one direction.

4. The illumination system according to claim 3, wherein the birefringent prism is wedge-shaped, and the polarisation state of a light beam passing therethrough varies continuously along the at least one direction.

5. The illumination system according to claim 3, wherein the birefringement prism has a stepped thickness profile, and the polarisation state of a light beam passing therethrough varies discontinuously along the at least one direction.

6. The illumination system according to claim 3, wherein the birefringent prism has an optical birefringence axis which makes an angle of 45° with a polarisation direction of the linearly polarised light.

7. The illumination system according to claim 1, wherein the second arrangement comprises a diffractive optical element which has locally varying diffraction properties.

8. The illumination system according to claim 7, wherein the diffractive optical element comprises at least two strips, arranged mutually parallel, with different diffraction properties.

9. The illumination system according to claim 8, wherein the diffraction properties of the at least two strips change periodically.

10. The illumination system according to claim 8, wherein:
the first arrangement comprises:
a light source configured to generate linearly polarised and at least partially spatially coherent projection light; and
a birefringent prism configured to modify the polarisation state of a light beam passing therethrough, periodically along at least one direction; and
the at least two strips are parallel to a direction which extends perpendicularly to an optical axis of the illumination system and perpendicularly to a direction along which the thickness of the birefringent prism varies.

11. The illumination system according to claim 8, wherein a first strip of the at least two strips diffracts the light in a plurality of directions in a first plane, and a second strip of the at least two strips diffracts the light in a plurality of directions in a second plane that is perpendicular to the first plane.

12. The illumination system according to claim 11, wherein the first strip generates a dipole distribution in a first direction in the first plane in the far-field, the second strip generates a dipole distribution in a second direction in the first plane in the far-field, the second direction is different from the first direction.

13. The illumination system according to claim 8, wherein the width of the at least two strips is such that the light passing through an individual strip has a preferential polarisation direction when superposed on one of the at least two positions.

14. The illumination system according to claim 13, wherein a width the at least two strips is equal to a half of the period with which the polarisation state of the light beam passing therethrough varies periodically.

15. The illumination system according to claim 8, wherein a width of the at least two strips is such that the light passing through an individual strip is at least essentially polarised linearly when superposed on one of the at least two positions.

16. The illumination system according to claim 8, wherein the at least two strips have a width such that the light passing through a strip is spatially coherent.

17. The illumination system according to claim 1, comprising an excimer laser as a light source.

18. The illumination system according to claim 8, wherein the at least two strips have a width less than 0.5 mm.

19. The illumination system according to claim 8, wherein the at least two strips have a width less than 0.25 mm.

20. The illumination system according to claim 1, comprising a light source that generates light with a wavelength of less than 200 nm.

21. The illumination system according to claim 1, wherein the second arrangement splits the light beam onto the pupil plane onto at least four poles, and the pupil polarisation states are equal respectively in pairs of mutually diametrically opposite poles.

22. The illumination system according to claim 21, wherein the pupil polarisation state of one pair is orthogonal to the pupil polarisation state of the other pair.

23. The illumination system according to claim 21, wherein the poles have an at least approximately equal shape.

24. The illumination system according to claim 21, wherein the light has an additional pole at the pupil plane, the additional pole containing an optical axis of the illumination system and in which the light is essentially unpolarised or circularly polarised.

25. An illumination system, comprising:
a birefringent prism having a changing thickness along a direction; and
an optical superposition device configured to superpose polarisation states generated by the birefringent prism so that a locally varying polarisation state is obtained in a pupil plane of the illumination system,
wherein the illumination system is configured to be used in a microlithographic projection exposure apparatus.

26. The illumination system according to claim 25, wherein the birefringent prism is wedge-shaped or stepped.

27. The illumination system according to claim 25, further comprising a light source configured to generate linearly polarised and at least partially spatially coherent projection light.

28. An illumination system, comprising:
a birefringent prism having a changing thickness along a first direction; and
a diffractive optical element arranged behind the birefringent prism in a light path through the illumination system, the diffractive optical element having locally varying diffraction properties,
wherein the illumination system is configured to be used in a microlithographic projection exposure apparatus.

29. The illumination system according to claim 28, wherein the diffractive optical element has a plurality of differently structured strips parallel to a second direction that extends perpendicularly to an optical axis of the illumination system and perpendicularly to the first direction.

30. The illumination system according to claim 28, wherein the prism is wedge-shaped or stepped.

31. An illumination system, comprising:
a light source configured to generate light; and
a diffractive optical element having regions with different diffraction properties, the regions being less than 0.5 mm along at least one direction,
wherein the illumination system is configured to be used in a microlithographic projection exposure apparatus.

32. The illumination system according to claim 31, wherein the regions are less than 0.25 mm along the at least one direction.

33. An apparatus, comprising:
an illumination system as recited in claim 1; and
a projection objective,
wherein the apparatus is a microlithographic projection exposure apparatus.

34. A method, comprising:
using the apparatus of claim 33 to produce microstructured components.
